(19) United States
(12) Patent Application Publication
(10) Pub. No.: US 2001/0038381 A1
(43) Pub. Date: Nov. 8, 2001

(54) ILLUMINATED POINTING DEVICE FOR A COMPUTER

(76) Inventor: RICHARD W. GRIENCEWIC, MCCOOK LAKE, SD (US)

Correspondence Address: SCHWEGMAN LUNDBERG, WOESSNER & KLUTH, PO BOX 2938, MINNEAPOLIS, MN, 55402

(21) Appl. No.: 08/971,320

(22) Filed: Nov. 17, 1997

(51) Int. Cl. G09G 5/08

(52) U.S. Cl. 345/163

(57) ABSTRACT

An illuminated pointing device for a computer is disclosed. The pointing device comprises a sensor, a communications link and a housing. The sensor translates movement by a user of the computer to a signal representing a desired corresponding change in the position of a pointer on a display of the computer. The communications link provides for the signal to be sent to the computer. The housing has one or more illuminated exterior surfaces to render the device visible in a low-light or no-light environment.

### FIELD OF THE INVENTION

This invention relates generally to a pointing device for a computer, and more particularly to such a pointing device that is illuminated.

### BACKGROUND OF THE INVENTION

Personal computers, such as the Gateway 2000 personal computer, typically come equipped with a pointing device such as a mouse. Furthermore, laptop computers, such as the Gateway Solo, increasingly come equipped with a pointing device such as a touch pad built in, which may be more convenient for a user of the computer. Keyboards for desktop computers are mirroring this trend, and are increasingly including a built-in pointing device such as a touch pad as well. A pointing device allows the computer user to, among other things, control a pointer on the screen in a windows-based operating environment, such as Microsoft Windows 95.

Although such pointing devices are easy to use in well-lit environments, they may not be in low-light or no-light environments, even though computer use in such environments is increasing. In the past, computers had primarily only been used in professional settings, such as offices, in which lighting conditions are good. A user can easily locate a pointing device in such a well-lit environment, because the device is visible.

However, many times computers are not used in well lit environments. For example, a user using a laptop computer in an airplane during a night-time flight may find it difficult to easily locate the pointing device. For further example, a home user may want to operate the computer in the dark for certain applications, such as game playing. This user, too, may find it difficult to easily locate the pointing device.

Currently such users have little recourse. The air traveler may just have to fumble around in an attempt to locate the pointing device. The home user may be forced to turn on the lights in order to locate the device. In either situation, because the pointing device is not very visible in low-light or no-light conditions, the user wastes time locating the device as compared to if the user were in a well-lit environment.

There is a need, therefore, for providing for a pointing device that is conducive to operation in a low-light or no-light operating environment. Such a device should allow a user of a computer to easily locate the device, even in a no-light or low-light operating environment. That is, such a device should allow the user to locate the device as easily as if the user were operating the computer in a well-lit environment.

### SUMMARY OF THE INVENTION

The present invention provides for an illuminated pointing device for a computer. A first embodiment of the invention is a touch pad pointing device for a computer. The touch pad comprises a sensor, a communications link, and a housing. The sensor translates movement by a user of the computer to a signal representing a desired corresponding change in the position of a pointer on display of the computer. The communications link provides for the signal to be sent to the computer. The housing has one or more illuminated exterior surfaces to render the device visible in a low-light or no-light environment.

In this manner, the present invention provides a pointing device that is conducive to operation in a low-light or no-light environment. The pointing device is illuminated. Therefore, it is easily located in a low-light or no-light environment with a minimum of fumbling by the user, and without the user having to turn on an exterior light source. The illuminated pointing device is optimally as easily located in a no-light or low-light operating environment as if the device were in a well-lit operating environment.

Other embodiments of the invention include a laptop computer having such a touch pad that is integral, a computer keyboard having such a touch pad that is integral, and a computerized system comprising a computer and an external illuminated pointing device, such as a touch pad, a mouse, a point stick, a joystick, or a trackball. Still other and further embodiments, aspects and advantages of the present invention will become apparent in the following description and by reference to the accompanying drawings.

### BRIEF DESCRIPTION OF THE DRAWINGS

FIG. 1(a) is a diagram of a typical computer in conjunction with which the present invention may be used;

FIG. 1(b) is a diagram of a typical laptop computer having an integrated touch pad, in conjunction with which the invention may be used;

FIG. 1(c) is a diagram of a typical keyboard having an integrated touch pad, in conjunction with which the invention may be used;

FIG. 2 is a diagram of a typical touch pad pointing device according to the present invention;

FIG. 3 is a diagram of an exterior surface of a touch pad pointing device according to the present invention that is illuminated by electroluminescence;

FIG. 4 is a diagram of an exterior surface of a touch pad pointing device according to the present invention that is illuminated by the use of light pipes;

FIG. 5(a) is a diagram of a typical mouse pointing device in conjunction with which the invention may be implemented;

FIG. 5(b) is a diagram of a typical trackball pointing device disposed within a computer, in conjunction with which the invention may be implemented; and,

FIG. 5(c) is a diagram of a typical point stick pointing device disposed within a keyboard, in conjunction with which the invention may be implemented.

### DETAILED DESCRIPTION OF THE DRAWINGS

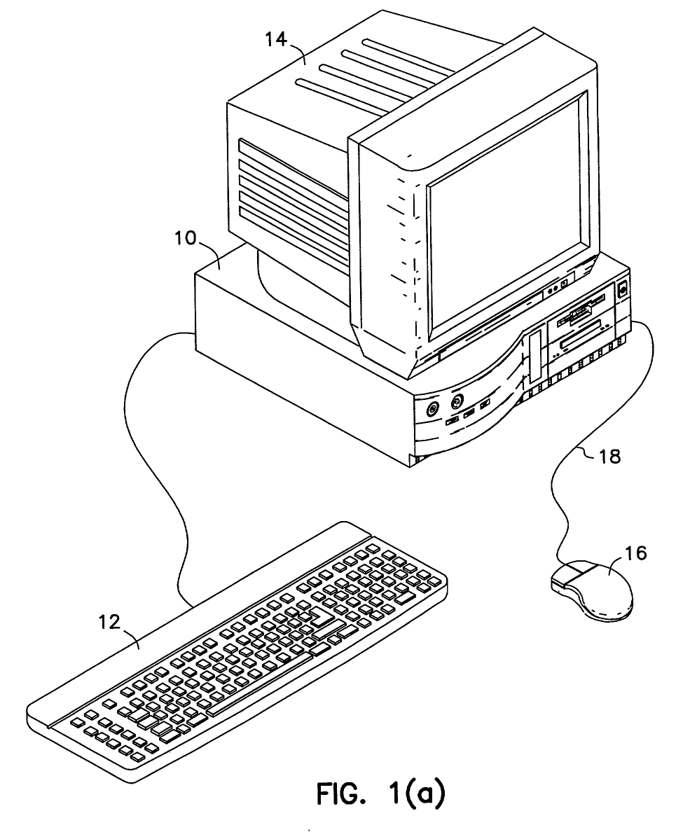

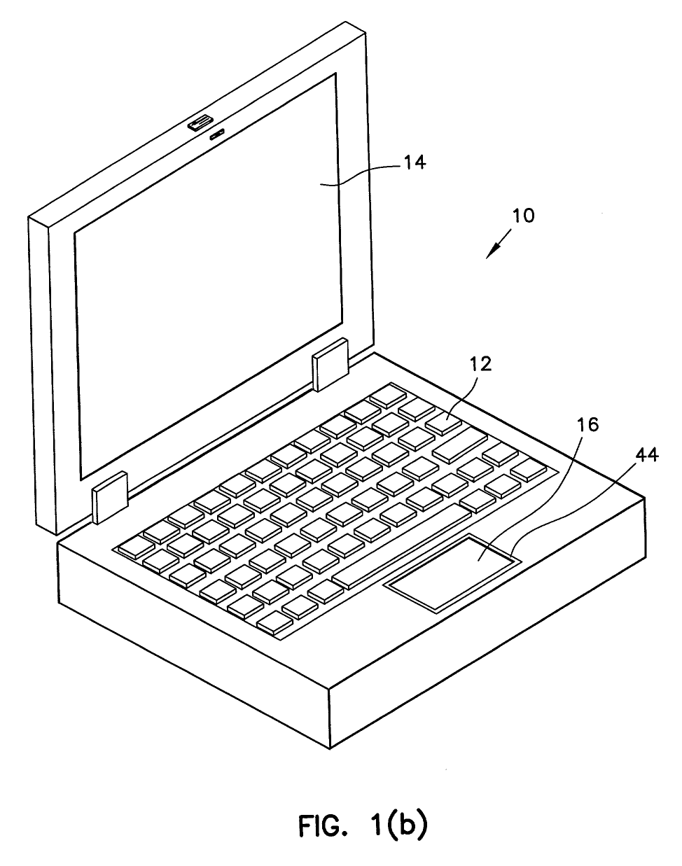

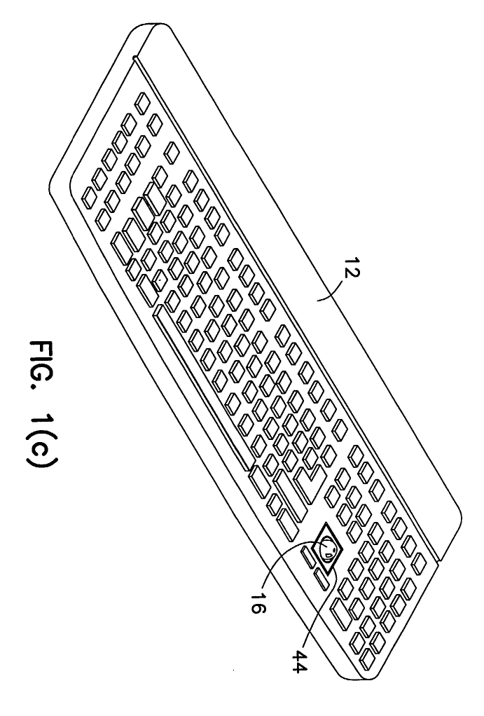

The present invention provides for an illuminated pointing device for a computer. A diagram of a typical computer in conjunction with which the present invention can be used is shown in FIG. 1(a). Computer 10 usually includes keyboard 12, display device 14 and mouse pointing device 16. Not shown is that computer 10 typically also comprises a random-access memory (RAM), a central-processing unit (CPU), and one or more storage devices, such as a hard disk drive, a floppy disk drive, or a tape cartridge drive, although the invention is not so limited. As shown, computer 10 is a desktop computer, such as a Gateway 2000 personal computer, although the invention is not so limited. For example, computer 10 could also be a laptop computer such as a Gateway 2000 Solo.

Computer 10 typically has a program running thereon that provides for movement of a pointer on display device 14 in response to the user operating mouse pointing device 16. One such program is Microsoft Windows 95. Another such program is the Apple Macintosh Operating System. Display device 14 can be any of a number of different devices, such as a computer monitor employing a cathode ray tube (CRT).

Mouse pointing device 16 is a device allows a computer user to move the pointer on display device 14. Mouse pointing device 16 therefore translates movement by the user into an electronic signal sent to the computer via a communications link. As shown in FIG. 1(a), the communications link is cable 18 connecting the pointing device to the computer. Such a cable 18 is usually integrated within the pointing device itself, and ends in a connector that plugs into a corresponding connector in the back of the computer. This connector may, for example, be a serial nine-pin or twenty-five pin connector that are typically used with PC-compatible computers.

However, the invention is not limited as to the particular manner in which the pointing device communicates with the computer. For example, the pointing device may have an integrated transmitter that allows for wireless communication with a corresponding receiver of the computer. Such a transmitter-receiver combination may provide radio frequency, or infrared, communication, both of which are well known to those of ordinary skill in the art.

As shown in FIG. 1(a), mouse 16 is an external device. The invention is not so limited, however. In the case of the invention where computer 10 is a laptop computer, the pointing device may be integrated within the computer itself, as is known to those of ordinary skill in the art, as is shown in FIG. 1(b). In addition, the pointing device may be integrated within keyboard 12, as is shown in FIG. 1(c).

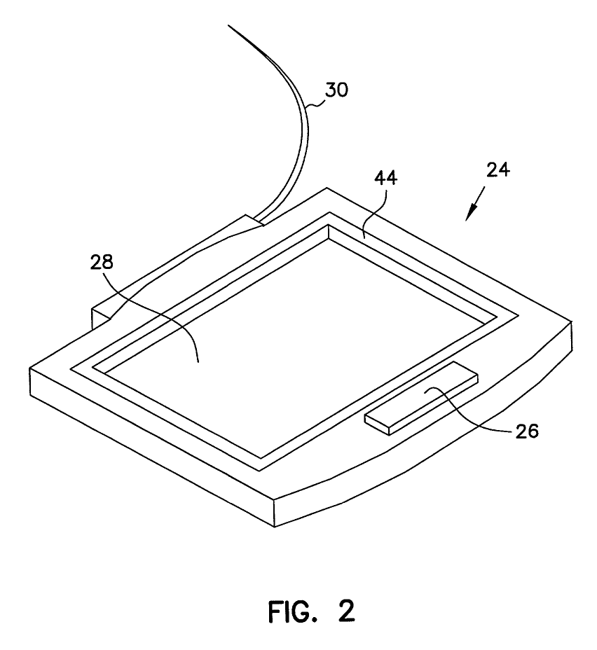

Referring now to FIG. 2, a touch pad pointing device is shown in detail. A touch pad is a touch-sensitive pad. The pad detects the positions at which the user is moving his or her finger on the pad, and conveys this information to the computer. The computer then moves the pointer based on the information. The touch pad typically allows the “clicking” of a button within a window in a windows-based operating environment in one of two ways. First, the touch pad may have one or more separate buttons for this function. Second, the touch pad may allow the user to tap the pad to effect a click.

As shown in FIG. 2, the touch pad comprises shell 24, button 26, sensing pad 28, and cable 30. The touch pad also includes rim 44, which surrounds pad 28. As described for the purposes herein, what is referred to as the housing of the touch pad includes all of its exterior surfaces, including rim 44, shell 24, button 26 and the exterior surface of sensing pad 28. Shell 24 may itself comprise a number of different exterior surfaces. Cable 30 is the communications link of the touch pad pointing device shown in FIG. 2. Not shown is that cable 30 typically ends in a connector for plugging into a corresponding connector on the back of a computer.

The touch pad device includes a sensor for the device that translates movement by a user of the computer on sensing pad 28 to a signal representing a desired corresponding change in the position of a pointer on the display device of the computer. The signal representing this information is transmitted to the computer over the communications link.

According to the invention, one or more of the exterior surfaces of the housing are illuminated. That is, as shown in FIG. 2, either one of the surfaces of shell 24 is illuminated, button 26 is illuminated, rim 44 is illuminated, or the exterior surface of pad 28 is illuminated. The manner in which the exterior surfaces are illuminated is not a limitation according to the present invention. The exterior surfaces can be illuminated in any of a number of different ways, as will be described herein.

In one embodiment, rim 44 is preferably translucent and is the exterior surface of the housing of the touch pad that is illuminated. A light source within the housing is visible through rim 44 because it is translucent. In this embodiment, the other surfaces of the housing are opaque, and do not let the light through.

In one embodiment of the invention, one or more of the exterior surfaces of the housing of the pointing device are electroluminescent. Each of these surfaces comprises two separate layers. This is shown in FIG. 3, in which an exemplary exterior surface comprises an underlying electroluminescent layer 40 and a top layer 42. Top layer 42 is typically transparent, and protects underlying electroluminescent layer 40, which is typically sensitive to damage. Electroluminescent layer 40 is itself coupled to power supply 41. Power supply 41 typically is the same power supply that provides power to the computer coupled to the pointing device. When the power is turned on, electroluminescent layer 40 glows, and the pointing device is therefore illuminated. Electroluminescent layer 40 operates on the principle of electroluminescence.

Electroluminescence involves the flowing of electric current through a series of semiconductor devices, typically made from materials such as silicon or gallium arsenide. The voltage used by these devices is typically quite low, and is on the order of 1-5 volts; therefore, the power supply powering the devices can be a very small battery. The construction of an electroluminescent layer, such as layer 40 as shown in FIG. 3, is well known by those of ordinary skill in the art. One manner of such construction is disclosed in U.S. Pat. No. 4,238,793. Electroluminescence is also described in materials available from BKL, Inc., of King of Prussia, Pa., which are hereby incorporated by reference.

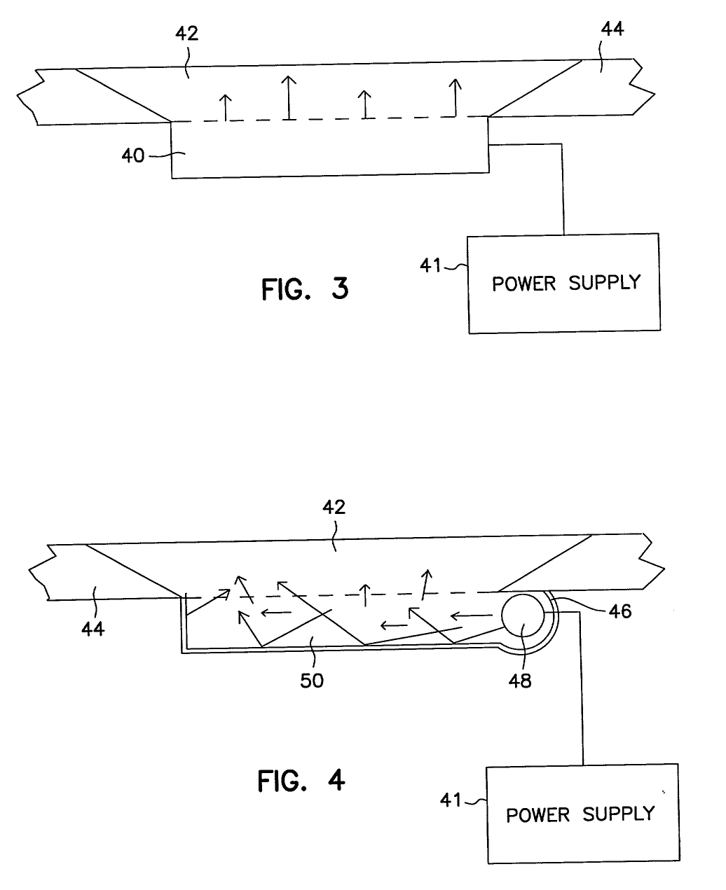

In another embodiment of the invention, one or more of the exterior surfaces of the housing of the pointing device are illuminated by one or more light pipes distributing light from a light source across the surfaces. This is shown in FIG. 4, in which an exemplary exterior surface 44 is lit by single light pipe 50 distributing light from light source 48 (which is powered via power supply 41), as reflected by reflective surface 46. In this manner, the pointing device is illuminated. The use of light pipe 50 ensures that the light from light source 48 is distributed more evenly across surface 44 than if light source 48 were used by itself. Reflective surface 46 ensures that the light emitting from light source 48 is directed towards light pipe 50, instead of back into the pointing device.

Various light pipe constructions are known and may be employed, each having different diffusion, scattering, reflection and distribution characteristics in order to reduce transmission losses and efficiently distribute light over the exterior surface. In one embodiment, light pipe 50 is constructed from a fiber optical material. Light source 48 is in one embodiment a cold cathode fluorescent tube, although the invention is not so limited.

The invention is not limited to the manner by which the illumination of the pointing device is turned on. As those of ordinary skill with readily understand, in differing embodiments the illumination is turned on and off via a physical control (e.g., a switch), a hot key on the keyboard, a configuration mode within the software driver of the pointing device, and via a light sensor on the pointing device.

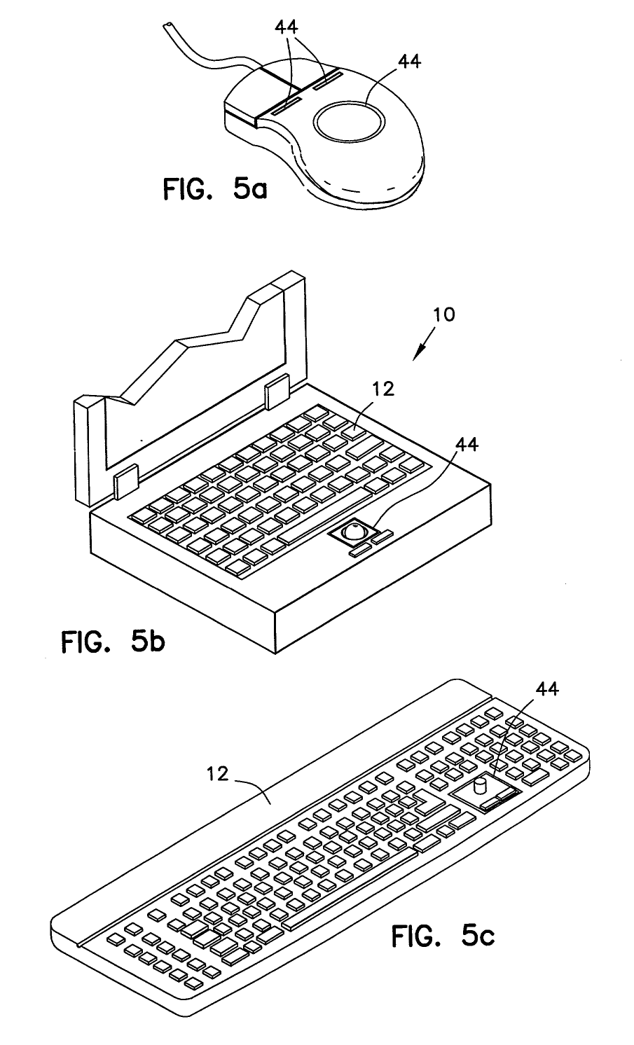

As has been described, the invention has been shown to apply to a touch pad pointing device. However, the invention is not so limited. Therefore, a mouse pointing device as shown in FIG. 5(a), a trackball pointing device (disposed within a laptop computer), as shown in FIG. 5(b), as well as a point stick pointing device (disposed within a keyboard), as shown in FIG. 5(c), are also amenable to the invention. Other pointing devices are also amenable to the invention (e.g., a joystick, etc.).

As has been described, the present invention provides a pointing device that is conducive to operation in a low-light or no-light environment. Two particular manners in which a pointing device can be illuminated have been disclosed, although the invention is not so limited. By providing for an illuminated pointing device, the present invention provides for such a device that is easily located in a low-light or no-light environment with a minimum of fumbling by the user, and without the user having to turn on an exterior light source. Those of ordinary skill in the art will readily appreciate that many changes and modifications to the above drawings and description can be made without departure from the spirit or scope of the following claims.

What is claimed is:

1. A pointing device for a computer, comprising:
a sensor to translate movement by a user of the computer to a signal representing a desired corresponding change in the position of a pointer on a display of the computer;
a communications link over which the signal is sent to the computer; and,
a housing having one or more illuminated exterior surfaces to render the device visible in a low-light or no-light environment.

2. The pointing device of claim 1, further comprising a power supply, wherein each illuminated exterior surface comprises a substantially transparent top layer and an underlying electroluminescent layer coupled to the power supply, the electroluminescent layer emitting visible light through the substantially transparent top layer.

3. The pointing device of claim 1, further comprising a light source and one or more light pipes, wherein the light pipes transmit light from the light source and distribute the light over the illuminated exterior surfaces.

4. A computer having a pointing device, the pointing device comprising:
a sensor to translate movement by a user of the computer to a signal representing a desired corresponding change in the position of a pointer on a display of the computer; and,
a housing having one or more illuminated exterior surfaces to render the device visible in a low-light or no-light environment.

5. The computer of claim 4, further comprising a power supply, wherein each illuminated exterior surface comprises a substantially transparent top layer and an underlying electroluminescent layer coupled to the power supply, the electroluminescent layer emitting visible light through the substantially transparent top layer.

6. The computer of claim 4, further comprising a light source and one or more light pipes, wherein the light pipes transmit light from the light source and distribute the light over the illuminated exterior surfaces.

7. A keyboard for a computer having an integral pointing device, the pointing device comprising:
a sensor to translate movement by a user of the computer to a signal representing a desired corresponding change in the position of a pointer on a display of the computer;
a communications link over which the signal is sent to the computer; and,
a housing having one or more illuminated exterior surfaces to render the device visible in a low-light or no-light environment.

8. The keyboard of claim 7, further comprising a power supply, wherein each illuminated exterior surface comprises a substantially transparent top layer and an underlying electroluminescent layer coupled to the power supply, the electroluminescent layer emitting visible light through the substantially transparent top layer.

9. The keyboard of claim 7, further comprising a light source and one or more light pipes, wherein the light pipes transmit light from the light source and distribute the light over the illuminated exterior surfaces.

10. A computerized system suitable for use in a low-light or no-light environment, comprising:
a computer; and,
an illuminated pointing device operatively coupled to the computer, the illuminated pointing device comprising:
a sensor to translate movement by a user of the computer to a signal representing a desired corresponding change in the position of a pointer on a display of the computer;
a housing having one or more illuminated exterior surfaces to render the device visible in a low-light or no-light environment.

11. The computerized system of claim 10, further comprising a power supply, wherein each illuminated exterior surface comprises a substantially transparent top layer and an underlying electroluminescent layer coupled to the power supply, the electroluminescent layer emitting visible light through the substantially transparent top layer.

12. The computerized system of claim 10, further comprising a light source and one or more light pipes, wherein the light pipes transmit light from the light source and distribute the light over the illuminated exterior surfaces.
